(19) United States
(12) Patent Application Publication
(10) Pub. No.: US 2026/0106356 A1
(43) Pub. Date: Apr. 16, 2026

(54) LITHIUM METAL SECONDARY BATTERY

(71) Applicant: HONDA MOTOR CO., LTD., Tokyo (JP)

(72) Inventors: Takayuki YAMAMOTO, Saitama (JP); Atsushi ASAHI, Saitama (JP); Akihiro TAGUCHI, Saitama (JP); Kazuya MATSUOKA, Saitama (JP); Masahiro HOKAZONO, Saitama (JP); Kenji TSUKAHARA, Saitama (JP); Fumikazu NAKAZAWA, Saitama (JP)

(21) Appl. No.: 19/352,482

(22) Filed: Oct. 8, 2025

(30) Foreign Application Priority Data
Oct. 10, 2024 (JP) 2024-177724

(51) Int. Cl. H01M 50/586; H01M 4/134; H01M 4/40; H01M 10/052; H01M 10/0562; H01M 10/42; H01M 50/474

(52) U.S. Cl. CPC H01M 50/586; H01M 4/134; H01M 4/405; H01M 10/052; H01M 10/0562; H01M 10/4235; H01M 50/474

(57) ABSTRACT

A lithium metal secondary battery according to an embodiment of the present invention includes: a positive electrode layer; a negative electrode layer; a solid electrolyte layer disposed between the positive electrode layer and the negative electrode layer; and an intermediate layer disposed between the negative electrode layer and the solid electrolyte layer. A lithium metal layer is disposed on a surface of the negative electrode layer on an intermediate layer side. An intermediate layer insulating material covering an outer peripheral surface of the intermediate layer is provided. The intermediate layer insulating material does not have lithium ion conductivity.

This application is based on and claims the benefit of priority from Japanese Patent Application No. 2024-177724, filed on 10 Oct. 2024, the content of which is incorporated herein by reference.

### BACKGROUND OF THE INVENTION

### Field of the Invention

The present invention relates to a lithium metal secondary battery.

### Related Art

In recent years, research and development has been conducted on secondary batteries that contribute to energy efficiency in order to ensure that more people have access to affordable, reliable, sustainable, and advanced energy. As a secondary battery, a lithium metal battery having a high energy density has attracted attention.

As a lithium metal secondary battery, for example, a laminated lithium metal secondary battery including a positive electrode layer, a negative electrode layer, and a solid electrolyte layer disposed between the positive electrode layer and the negative electrode layer is known. In addition, it has been studied to provide an intermediate layer between the negative electrode layer and the solid electrolyte layer.

Japanese Unexamined Patent Application, Publication No. 2022-062572 discloses that a layer (intermediate layer) having a higher affinity for metallic lithium than a solid electrolyte layer may be provided between the solid electrolyte layer and a negative electrode current collector. Japanese Unexamined Patent Application, Publication No. 2011-044368 discloses a technique of suppressing the formation of a high-resistance layer at an interface of a solid electrolyte layer on a positive electrode layer side by interposing an intermediate layer between a positive electrode layer and the solid electrolyte layer. Japanese Unexamined Patent Application, Publication No. 2024-031684 discloses a technique of covering at least one of outer peripheral surfaces of an intermediate layer along a stacking direction with a protective layer having ionic conductivity and no electron conductivity in a lithium metal secondary battery including the intermediate layer.

Patent Document 1: Japanese Unexamined Patent Application, Publication No. 2022-062572

Patent Document 2: Japanese Unexamined Patent Application, Publication No. 2011-044368

Patent Document 3: Japanese Unexamined Patent Application, Publication No. 2024-031684

### SUMMARY OF THE INVENTION

In a lithium metal secondary battery including an intermediate layer between a negative electrode layer and a solid electrolyte layer, it is preferable to cause lithium metal to be uniformly deposited on the surface of the negative electrode layer on an intermediate layer side during charging so that dendrites are less likely to be generated. In the lithium metal secondary battery disclosed in Japanese Unexamined Patent Application, Publication No. 2024-031684, the outer peripheral surface of the intermediate layer is covered with the protective layer having ionic conductivity and no electron conductivity, and lithium ions are guided to the protective layer to suppress deposition of lithium metal on the outer peripheral surface of the intermediate layer. As a result, lithium metal is uniformly deposited on the surface of the negative electrode layer on an intermediate layer side, and dendrites are less likely to be generated. However, it is desirable that lithium metal is uniformly deposited on the surface of the negative electrode layer on the intermediate layer side without guiding lithium ions to the protective layer other than the solid electrolyte layer and the intermediate layer, so that dendrites are less likely to be generated.

It is an object of the present invention to provide a lithium metal secondary battery including an intermediate layer between a negative electrode layer and a solid electrolyte layer and having a novel structure in which lithium metal can be uniformly deposited on the surface of the negative electrode layer on an intermediate layer side and dendrites are less likely to be generated. This contributes to energy efficiency.

The present inventors have found that, in a lithium metal secondary battery including an intermediate layer between a negative electrode layer and a solid electrolyte layer, by covering the outer peripheral surface of the intermediate layer with an intermediate layer insulating material having no lithium ion conductivity, lithium metal can be uniformly deposited on the surface of the negative electrode layer on an intermediate layer side, and dendrites are less likely to be generated, and have completed the present invention. Accordingly, the present invention provides the following.

A first aspect of the present invention is a lithium metal secondary battery including: a positive electrode layer; a negative electrode layer; a solid electrolyte layer disposed between the positive electrode layer and the negative electrode layer; and an intermediate layer disposed between the negative electrode layer and the solid electrolyte layer. A lithium metal layer is disposed on a surface of the negative electrode layer on an intermediate layer side. An intermediate layer insulating material covering an outer peripheral surface of the intermediate layer is provided. The intermediate layer insulating material does not have lithium ion conductivity.

According to the lithium metal secondary battery of the first aspect, since the lithium metal layer is disposed on the surface of the negative electrode layer on the intermediate layer side, lithium is easily deposited. Additionally, since the intermediate layer insulating material covering the outer peripheral surface of the intermediate layer does not have lithium ion conductivity, lithium ions are less likely to move through the intermediate layer insulating material, and the supply of electrons e⁻ can be reliably blocked. Furthermore, since the outer peripheral surface of the intermediate layer is covered with the intermediate layer insulating material, the intermediate layer is less prone to powder shedding. Therefore, as the intermediate layer is less likely to be missing due to powder shedding of the intermediate layer, the solid electrolyte layer and the negative electrode layer are less likely to come into direct contact with each other. Therefore, according to the lithium metal secondary battery 1 of the present embodiment, since lithium ions stably move between the solid electrolyte layer and the negative electrode layer via the intermediate layer, lithium metal can be uniformly deposited on the surface of the lithium metal layer of the negative electrode layer, and dendrites are less likely to be generated.

In a second aspect of the present invention according to the first aspect, in top view, an outer edge of the intermediate layer insulating material overlaps an outer edge of the solid electrolyte layer and is located outward of an outer edge of the lithium metal layer.

According to the lithium metal secondary battery of the second aspect, even when the solid electrolyte layer deforms toward the negative electrode layer, the solid electrolyte layer and the lithium metal layer are less likely to come into contact with each other because the intermediate layer insulating material is present between the solid electrolyte layer and the lithium metal layer.

In a third aspect of the present invention according to the first aspect, in top view, an outer edge of the intermediate layer insulating material, an outer edge of the solid electrolyte layer, and an outer edge of the lithium metal layer overlap each other.

According to the lithium metal secondary battery of the third aspect, when the solid electrolyte layer deforms toward the negative electrode layer, the lithium metal layer also deforms in the same manner, and thus the solid electrolyte layer and the lithium metal layer are less likely to come into contact with each other.

In a fourth aspect of the present invention according to any one of the first to third aspects, in top view, an outer edge of the intermediate layer is located inward of an outer edge of the solid electrolyte layer and inward of an outer edge of the lithium metal layer.

According to the lithium metal secondary battery of the fourth aspect, lithium ions that have moved through the intermediate layer are less likely to move to the outer peripheral side of the lithium metal layer, and lithium is less likely to deposit on the outer periphery of the lithium metal layer. Therefore, the lithium metal can be more uniformly deposited on the surface of the lithium metal layer on the intermediate layer side, and dendrites are less likely to be generated.

In a fifth aspect of the present invention according to the first aspect, the positive electrode layer includes a positive electrode active material layer. In top view, an outer edge of the positive electrode active material layer is located inward of an outer edge of the intermediate layer, the outer edge of the intermediate layer overlaps an outer edge of the lithium metal layer or is located inward of the outer edge of the lithium metal layer, and the outer edge of the lithium metal layer is located between edges of the intermediate layer insulating material.

According to the lithium metal secondary battery of the fifth aspect, since the creepage distance between the positive electrode active material layer and the lithium metal layer becomes longer, short circuits between the positive electrode layer and the negative electrode layer are less likely to occur.

In a sixth aspect of the present invention according to any one of the first to fifth aspects, the intermediate layer insulating material includes alumina.

According to the lithium metal secondary battery of the sixth aspect, since the intermediate layer insulating material includes alumina, lithium ions are further less likely to move through the intermediate layer insulating material, and the supply of electrons e⁻ can be more reliably blocked.

According to the present invention, it is possible to provide a lithium metal secondary battery including an intermediate layer and having a novel structure in which lithium metal can be uniformly deposited on the surface of a negative electrode layer on an intermediate layer side and dendrites are less likely to be generated.

### BRIEF DESCRIPTION OF THE DRAWINGS

FIG. 1 is a plan view showing the configuration of a lithium metal secondary battery according to a first embodiment;

FIG. 2 is a cross-sectional view taken along line II-II of FIG. 1;

FIG. 3 is a cross-sectional view taken along line III-III of FIG. 1;

FIG. 4A is a cross-sectional view of a solid electrolyte layer-intermediate layer laminate manufactured in the manufacturing process of the lithium metal secondary battery according to the first embodiment;

FIG. 4B is a cross-sectional view of a positive electrode layer-solid electrolyte layer-intermediate layer laminate manufactured in the manufacturing process of the lithium metal secondary battery according to the first embodiment;

FIG. 5 is a cross-sectional view showing the configuration of a lithium metal secondary battery according to a second embodiment;

FIG. 6A is a cross-sectional view of a negative electrode layer used in the manufacturing process of the lithium metal secondary battery according to the second embodiment; and

FIG. 6B is a cross-sectional view of a solid electrolyte layer-intermediate layer-negative electrode layer laminate manufactured in the manufacturing process of the lithium metal secondary battery according to the second embodiment.

### DETAILED DESCRIPTION OF THE INVENTION

### First Embodiment

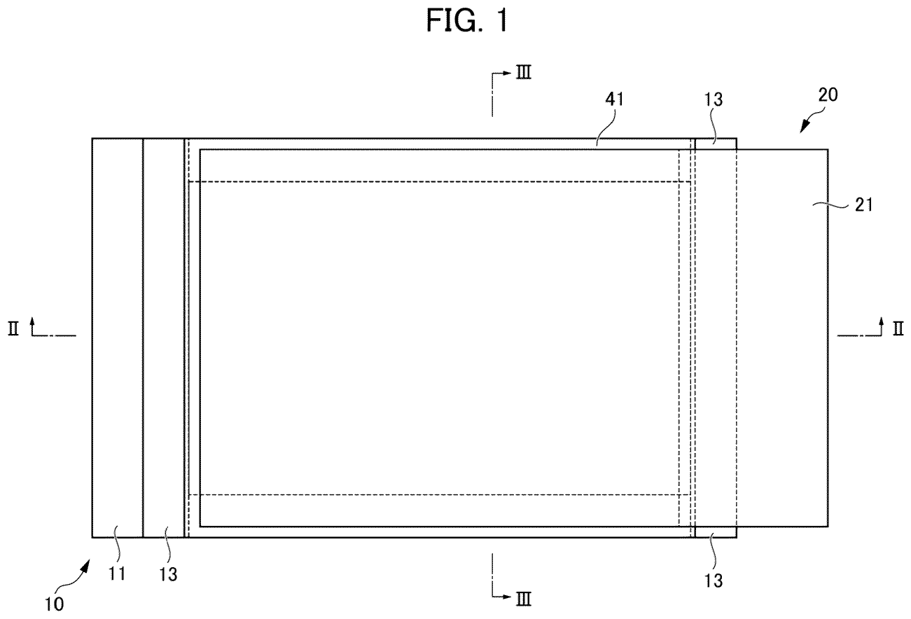

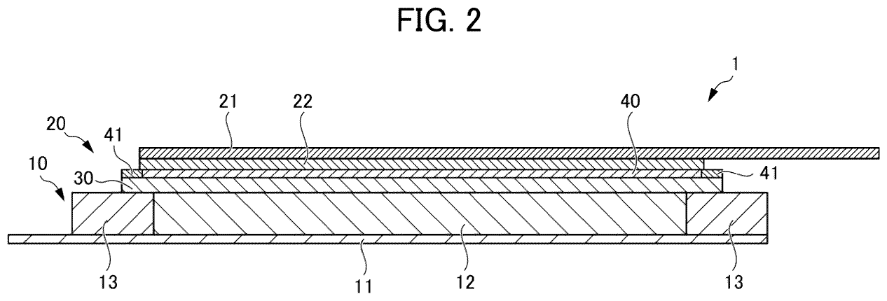

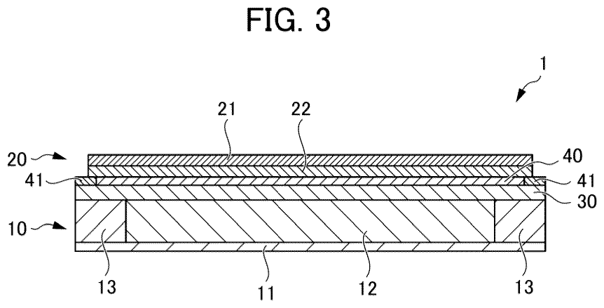

A lithium metal secondary battery according to a first embodiment of the present invention will be described with reference to FIGS. 1 to 3. FIG. 1 is a plan view showing the configuration of the lithium metal secondary battery according to the first embodiment. FIG. 2 is a cross-sectional view taken along line II-II of FIG. 1, and is a cross-sectional view in a direction along an extension direction of a positive electrode current collector 11 and a negative electrode current collector 21 of a lithium metal secondary battery 1. FIG. 3 is a cross-sectional view taken along line III-III of FIG. 1, and is a cross-sectional view in a direction perpendicular to the extension direction of the positive electrode current collector 11 and the negative electrode current collector 21 of the lithium metal secondary battery 1.

The lithium metal secondary battery 1 according to the present embodiment is a laminated lithium metal secondary battery 1 including a positive electrode layer 10, a negative electrode layer 20, a solid electrolyte layer 30 disposed between the positive electrode layer 10 and the negative electrode layer 20, and an intermediate layer disposed between the negative electrode layer 20 and the solid electrolyte layer 30. The positive electrode layer 10 and the negative electrode layer 20 extend in directions facing each other. The positive electrode layer 10 includes the positive electrode current collector 11 and a positive electrode active material layer 12 disposed on the solid electrolyte layer 30 side of the positive electrode current collector 11. The outer peripheral surface of the positive electrode active material layer 12 is covered with a positive electrode active material layer insulating frame 13. The negative electrode layer 20 includes the negative electrode current collector 21 and a lithium metal layer 22 disposed on the surface of the negative electrode current collector 21 on an intermediate layer 40 side.

The lithium metal secondary battery 1 further includes an intermediate layer insulating material 41 that covers the outer peripheral surface of the intermediate layer 40. The intermediate layer insulating material 41 has no electron conductivity and no lithium ion conductivity. Having no electron conductivity means that the electron conductivity is 10⁻⁶ S/m or less. Having no lithium ion conductivity means not conducting lithium ions during charging and discharging of the lithium metal secondary battery 1. The lithium ion conductivity of the intermediate layer insulating material 41 is lower than the lithium ion conductivity of the intermediate layer 40.

In the lithium metal secondary battery 1 of the present embodiment, lithium metal is deposited on the surface of the lithium metal layer 22 during charging, and the deposited lithium metal is released during discharging and moves to the positive electrode active material layer 12. Therefore, the thickness of the negative electrode layer 20 of the lithium metal secondary battery 1 changes greatly due to charging and discharging. Pressure is applied to the intermediate layer 40 due to changes in the thickness of the negative electrode layer 20 due to charging and discharging, which may cause powder shedding, where part of the outer peripheral surface of the intermediate layer 40 falls off. Further, during the manufacture of the lithium metal secondary battery 1, powder shedding may occur in part of the intermediate layer 40 due to the pressure applied when pressure-bonding the intermediate layer 40 and the solid electrolyte layer 30 or pressure-bonding the intermediate layer 40 and the lithium metal layer 22. The intermediate layer insulating material 41 has an effect of suppressing powder shedding of the intermediate layer 40. The intermediate layer insulating material 41 preferably covers the entire outer peripheral surface of the intermediate layer 40. By covering the entire outer peripheral surface of the intermediate layer 40 with the intermediate layer insulating material 41, the effect of further suppressing powder shedding of the intermediate layer 40 is enhanced.

The outer edge of each layer in top view of the lithium metal secondary battery 1 of the present embodiment is located at the following position. The outer edge means an end of a surface orthogonal to the laminating direction of the lithium metal secondary battery 1.

The outer edge of the solid electrolyte layer 30 is located outward of the outer edge of the lithium metal layer 22. The outer edge of the intermediate layer insulating material 41 overlaps the outer edge of the solid electrolyte layer 30.

The outer edge of the intermediate layer 40 is located outward of the outer edge of the positive electrode active material layer 12. However, the outer edge of the intermediate layer 40 may overlap the outer edge of the positive electrode active material layer 12. The outer edge of the intermediate layer 40 is located inward of the outer edge of the solid electrolyte layer 30. The outer edge of the intermediate layer 40 is located inward of the outer edge of the lithium metal layer 22.

The outer edge of the positive electrode active material layer 12 is located inward of the outer edge of the intermediate layer 40. However, the outer edge of the positive electrode active material layer 12 may overlap the outer edge of the intermediate layer 40. The outer edge of the positive electrode active material layer 12 is located inward of the outer edge of the lithium metal layer 22.

The outer edge of the positive electrode active material layer insulating frame 13 is located outward of the outer edge of the solid electrolyte layer 30 in the extending direction of the positive electrode current collector 11 and the negative electrode current collector 21. In the direction perpendicular to the extending direction of the positive electrode current collector 11 and the negative electrode current collector 21, the outer edge of the positive electrode active material layer insulating frame 13 overlaps the outer edge of the solid electrolyte layer 30. However, also in the direction perpendicular to the extending direction of the positive electrode current collector 11 and the negative electrode current collector 21, the outer edge of the positive electrode active material layer insulating frame 13 may be located outward of the outer edge of the solid electrolyte layer 30.

In the lithium metal secondary battery 1, examples of the material for the positive electrode current collector 11 include aluminum, an aluminum alloy, stainless steel, nickel, iron, and titanium.

The positive electrode active material layer 12 contains a positive electrode active material. The positive electrode active material is a lithium compound that releases lithium ions during discharging and absorbs lithium ions during charging. As the lithium compound, for example, a layered active material, a spinel active material, or an olivine active material can be used. Specific examples of the positive electrode active material include lithium cobaltate (LiCoO₂), lithium nickelate (LiNiO₂), lithium nickel manganese cobalt oxide (NMC: LiNiₚMn_{q}CoᵣO₂ (p+q+r=1)), LiNiₚAl_{q}CoᵣO₂ (p+q+r=1), lithium manganate (LiMn₂O₄), heterogenous element-substituted Li—Mn spinel represented by Li₁₊ₓMn₂₋ₓ₋M_{y}O₄ (x+y=2, M is at least one selected from Al, Mg, Co, Fe, Ni, or Zn), lithium titanate (an oxide containing Li and Ti), and lithium metal phosphate (LiMPO₄, M is at least one selected from Fe, Mn, Co, or Ni). The positive electrode active material layer 12 may further contain a conductivity aid and a binder.

The positive electrode active material layer insulating frame 13 is not particularly limited as long as it has electronic insulation properties. The positive electrode active material layer insulating frame 13 may or may not have lithium ion conductivity. Examples of the material for the positive electrode active material layer insulating frame 13 include insulating oxides such as alumina, resins such as polyvinylidene fluoride (PVDF), and rubbers such as styrene-butadiene rubber (SBR).

Examples of the material for the negative electrode current collector 21 include copper, a copper alloy, nickel, and stainless steel.

The lithium metal layer 22 may be any layer as long as lithium ions are deposited during charging. As the material for the lithium metal layer 22, lithium and a metal that forms an alloy with lithium can be used. Examples of the metal that forms an alloy with lithium include Mg, Si, Au, Ag, In, Ge, Sn, Pb, Al, and Zn.

The solid electrolyte layer 30 includes a solid electrolyte. Examples of the solid electrolyte include a sulfide solid electrolyte, an oxide solid electrolyte, a nitride solid electrolyte, and a halide solid electrolyte. Examples of the sulfide solid electrolyte include Li₂S—P₂S₅ and Li₂S—P₂S₅—LiI. The sulfide solid electrolyte may have an argyrodite-type crystal structure. Examples of the oxide solid electrolyte include a NASICON type oxide, a garnet type oxide, and a perovskite type oxide. Examples of the NASICON type oxide include oxides containing Li, Al, Ti, P, and O (e.g., Li_{1.5}Al_{0.5}Ti_{1.5}(PO₄)₃). Examples of the garnet type oxide include oxides containing Li, La, Zr, and O (e.g., Li₇La₃Zr₂O₁₂). Examples of the perovskite oxide include oxides containing Li, La, Ti, and O (e.g., LiLaTiO₃). The solid electrolyte layer 30 may contain a binder in addition to the solid electrolyte material.

The intermediate layer 40 may be a layer having voids through which lithium ions can pass. The passage of lithium ions through the intermediate layer 40 allows lithium metal to be uniformly deposited on the surface of the lithium metal layer 22. Furthermore, the intermediate layer 40 has voids and is flexible, so that it can follow a change in thickness of the lithium metal secondary battery 1 that occurs during charging and discharging.

The material for the intermediate layer 40 is not particularly limited, and the intermediate layer 40 includes, for example, amorphous carbon, metal nanoparticles, and a binder. The amorphous carbon may be graphitizable carbon (soft carbon), or may be non-graphitizable carbon (hard carbon), CNT (carbon nanotube), fullerene, or graphene. Examples of the amorphous carbon include carbon blacks such as acetylene black, furnace black, and Ketjenblack, coke, and activated carbon. Examples of the metal nanoparticles include metal nanoparticles of tin (Sn), silicon (Si), zinc (Zn), magnesium (Mg), gold (Au), platinum (Pt), palladium (Pd), silver (Ag), aluminum (Al), bismuth (Bi), and antimony (Sb). As the binder, for example, a PVDF polymer such as an acrylic acid polymer, a cellulose polymer, a styrene polymer, a vinyl acetate polymer, a urethane polymer, or a fluoroethylene polymer can be used.

The material for the intermediate layer insulating material 41 may be any material that does not have electron conductivity and does not have ionic conductivity. As the material for the intermediate layer insulating material 41, for example, ceramic or resin can be used. An example of the ceramic is alumina. The ceramic may be a sintered body, or may be a molded body molded using a binder as necessary.

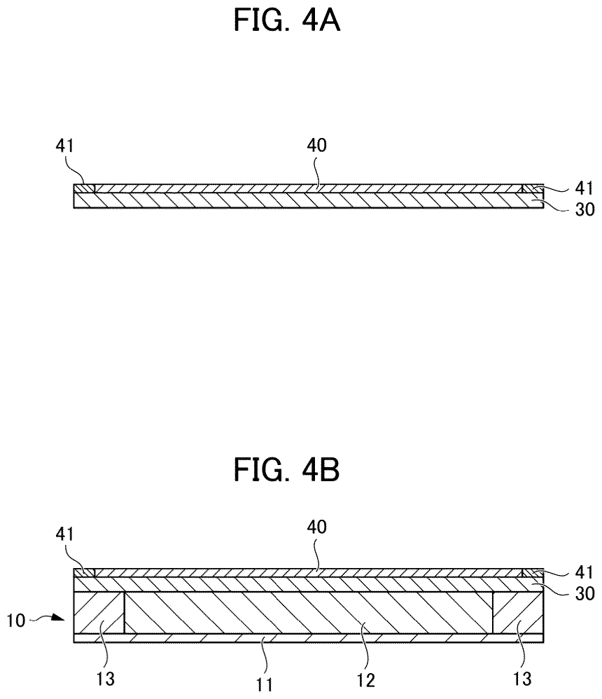

A method for manufacturing the lithium metal secondary battery 1 of the present embodiment will be described with reference to FIG. 4. FIGS. 4A and 4B are cross-sectional views showing the manufacturing process of the lithium metal secondary battery according to the first embodiment.

First, as shown in FIG. 4A, a solid electrolyte layer-intermediate layer laminate is obtained in which the intermediate layer 40 having the intermediate layer insulating material 41 disposed on its outer peripheral surface is laminated on one surface of the solid electrolyte layer 30. As a method for producing the solid electrolyte layer-intermediate layer laminate, for example, an overcoat method or a transfer method can be used. The overcoat method is a method in which the intermediate layer 40 is formed on the surface of a substrate, the intermediate layer insulating material 41 is formed along the outer peripheral surface of the intermediate layer 40, and then the solid electrolyte layer 30 is formed on the surfaces of the intermediate layer 40 and the intermediate layer insulating material 41. As a method of forming the intermediate layer 40, the intermediate layer insulating material 41, and the solid electrolyte layer 30, a coating method can be used. The coating method involves applying a material slurry containing materials for forming each layer and drying it. The transfer method is a method in which the solid electrolyte layer 30 and the intermediate layer 40 having the intermediate layer insulating material 41 disposed on its outer peripheral surface, which are formed on separate substrates, are pressure-bonded together.

Next, as shown in FIG. 4B, the positive electrode layer 10 is pressure-bonded to the surface of the solid electrolyte layer 30 of the solid electrolyte layer-intermediate layer laminate to obtain a positive electrode layer-solid electrolyte layer-intermediate layer laminate. The positive electrode layer 10 can be formed, for example, by forming the positive electrode active material layer 12 on the surface of the positive electrode current collector 11 and then covering the outer peripheral surface of the positive electrode active material layer 12 with the positive electrode active material layer insulating frame 13. As a method of forming the positive electrode active material layer 12 and the positive electrode active material layer insulating frame 13, the coating method can be used.

Next, the lithium metal layer 22 of the negative electrode layer 20 is pressure-bonded to the surface of the intermediate layer 40 of the positive electrode layer-solid electrolyte layer-intermediate layer laminate. Thus, the lithium metal secondary battery 1 is obtained.

According to the lithium metal secondary battery 1 of the present embodiment configured as described above, since the lithium metal layer 22 is disposed on the surface of the negative electrode layer 20 on the intermediate layer 40 side, lithium is easily deposited. Since the intermediate layer insulating material 41 covering the outer peripheral surface of the intermediate layer 40 has no lithium ion conductivity, lithium ions are less likely to move through the intermediate layer insulating material 41, and the supply of electrons e⁻ can be reliably blocked. Further, since the outer peripheral surface of the intermediate layer 40 is covered with the intermediate layer insulating material 41, the intermediate layer 40 is less prone to powder shedding. Therefore, as the intermediate layer 40 is less likely to be missing, the solid electrolyte layer 30 and the negative electrode layer 20 are less likely to come into direct contact with each other. Therefore, according to the lithium metal secondary battery 1 of the present embodiment, since lithium ions stably move between the solid electrolyte layer 30 and the negative electrode layer 20 via the intermediate layer 40, lithium metal can be uniformly deposited on the surface of the lithium metal layer 22 of the negative electrode layer 20, and dendrites are less likely to be generated.

In the lithium metal secondary battery 1 of the present embodiment, since the outer edge of the intermediate layer insulating material 41 overlaps the outer edge of the solid electrolyte layer 30 and is located outward of the outer edge of the lithium metal layer in top view, the intermediate layer insulating material 41 is present between the solid electrolyte layer 30 and the lithium metal layer 22 in the lithium metal secondary battery 1 even when the solid electrolyte layer 30 deforms toward the negative electrode layer 20. Therefore, the solid electrolyte layer 30 and the negative electrode layer 20 are less likely to come into contact with each other.

In the lithium metal secondary battery 1 of the present embodiment, since the outer edge of the intermediate layer 40 is located inward of the outer edge of the solid electrolyte layer 30 and is located inward of the outer edge of the lithium metal layer 22 in top view, lithium ions that have moved through the intermediate layer 40 are less likely to move to the outer peripheral side of the lithium metal layer 22, and lithium is less likely to be deposited on the outer periphery of the lithium metal layer 22. Therefore, in the lithium metal secondary battery 1, lithium metal can be more uniformly deposited on the surface of the lithium metal layer 22 on the intermediate layer 40 side, and dendrites are less likely to be generated.

In the lithium metal secondary battery 1 of the present embodiment, in top view, the outer edge of the positive electrode active material layer 12 is located inward of the outer edge of the intermediate layer 40, the outer edge of the intermediate layer 40 is located inward of the outer edge of the lithium metal layer 22, and the outer edge of the lithium metal layer 22 is located between the edges of the intermediate layer insulating material 41, so that the creepage distance between the positive electrode current collector 11 and the negative electrode current collector 21 becomes longer by the thickness of the intermediate layer and the amount by which the outer edge of the intermediate layer 40 is located inward of the outer edge of the lithium metal layer 22. Therefore, short circuits between the positive electrode layer 10 and the negative electrode layer 20 are less likely to occur.

In the lithium metal secondary battery 1 of the present embodiment, since in top view, the outer edge of the positive electrode active material layer insulating frame 13 is located outward of the outer edge of the solid electrolyte layer 30 in the extending direction of the positive electrode current collector 11 and the negative electrode current collector 21, the positive electrode current collector 11 and the negative electrode current collector 21 are less likely to come into contact with each other. Therefore, short circuits between the positive electrode layer 10 and the negative electrode layer 20 are less likely to occur in the extending direction of the positive electrode current collector 11 and the negative electrode current collector 21.

In the lithium metal secondary battery 1 of the present embodiment, when the intermediate layer insulating material 41 includes alumina, lithium ions are further less likely to move through the intermediate layer insulating material 41, and the supply of electrons e⁻ can be more reliably blocked.

### Second Embodiment

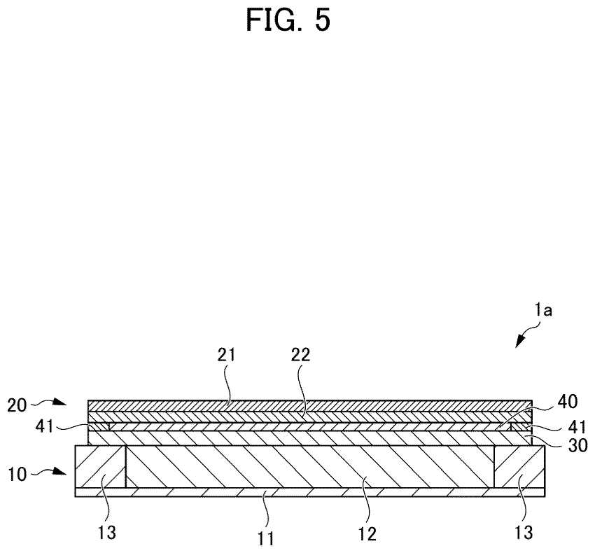

A lithium metal secondary battery according to a second embodiment of the present invention will be described with reference to FIG. 5. FIG. 5 is a cross-sectional view showing the configuration of the lithium metal secondary battery according to the second embodiment. FIG. 5 is a cross-sectional view of a lithium metal secondary battery 1a in a direction perpendicular to the extending direction of a positive electrode current collector 11 and a negative electrode current collector 21.

As shown in FIG. 5, the lithium metal secondary battery 1a has the same configuration as the lithium metal secondary battery 1 of the first embodiment except that the outer edge of an intermediate layer insulating material 41, the outer edge of a solid electrolyte layer 30, and the outer edge of a lithium metal layer 22 overlap each other, and therefore, the same reference numerals are used and the descriptions thereof are omitted.

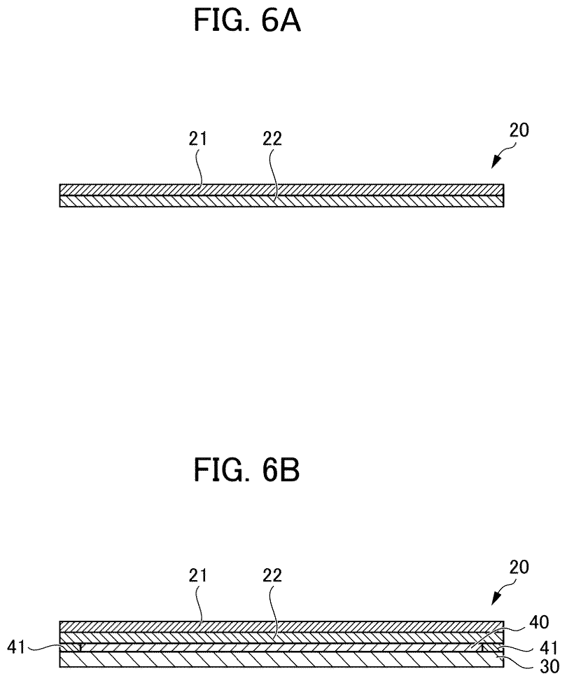

A method for manufacturing the lithium metal secondary battery 1a of the present embodiment will be described with reference to FIGS. 6A and 6B. FIGS. 6A and 6B are cross-sectional views showing the manufacturing process of the lithium metal secondary battery according to the second embodiment.

First, as shown in FIG. 6A, a negative electrode layer 20 in which the negative electrode current collector 21 and the lithium metal layer 22 are laminated is prepared.

Next, as shown in FIG. 6B, an intermediate layer 40 of a solid electrolyte layer-intermediate layer laminate in which the intermediate layer 40 having the intermediate layer insulating material 41 disposed on its outer peripheral surface is laminated on one surface of the solid electrolyte layer 30 is pressure-bonded to the surface of the lithium metal layer 22 of the negative electrode layer 20 to obtain a solid electrolyte layer-intermediate layer-negative electrode layer laminate. The method for producing the solid electrolyte layer-intermediate layer laminate is the same as the method for producing the solid electrolyte layer-intermediate layer laminate in the method for manufacturing the lithium metal secondary battery 1 of the first embodiment.

Next, a positive electrode active material layer 12 of a positive electrode layer 10 is pressure-bonded to the surface of the solid electrolyte layer 30 of the solid electrolyte layer-intermediate layer-negative electrode layer laminate. Thus, the lithium metal secondary battery 1a is obtained.

According to the lithium metal secondary battery 1a of the present embodiment configured as described above, since the lithium metal layer 22 is disposed on the surface of the negative electrode layer 20 on the intermediate layer 40 side and the intermediate layer insulating material 41 covering the outer peripheral surface of the intermediate layer 40 is provided, the same effect as that of the lithium metal secondary battery 1 of the first embodiment can be obtained. Further, in the lithium metal secondary battery 1a of the present embodiment, since the outer edge of the intermediate layer insulating material 41, the outer edge of the solid electrolyte layer 30, and the outer edge of the lithium metal layer 22 overlap each other, when the solid electrolyte layer 30 deforms toward the negative electrode layer 20, the lithium metal layer 22 also deforms in the same manner. Therefore, the solid electrolyte layer 30 and the lithium metal layer 22 are less likely to come into contact with each other.

In the present embodiment, the outer edge of each layer of the solid electrolyte layer 30, the intermediate layer insulating material 41, and the lithium metal layer 22 is located inward of the outer edge of a positive electrode active material layer insulating frame 13, but the outer edge of each layer may overlap the outer edge of the positive electrode active material layer insulating frame 13.

Although the preferred embodiments of the present invention have been described above, the present invention is not limited to the above embodiments, and modifications and improvements within a range capable of achieving the object of the present invention are included in the present invention.

### EXPLANATION OF REFERENCE NUMERALS

1, 1a lithium metal secondary battery
10 positive electrode layer
11 positive electrode current collector
12 positive electrode active material layer
13 positive electrode active material layer insulating frame
20 negative electrode layer
21 negative electrode current collector
22 lithium metal layer
30 solid electrolyte layer
40 intermediate layer
41 intermediate layer insulating material

What is claimed is:

1. A lithium metal secondary battery comprising:
a positive electrode layer; a negative electrode layer; a solid electrolyte layer disposed between the positive electrode layer and the negative electrode layer; and an intermediate layer disposed between the negative electrode layer and the solid electrolyte layer,
wherein a lithium metal layer is disposed on a surface of the negative electrode layer on an intermediate layer side,
wherein an intermediate layer insulating material covering an outer peripheral surface of the intermediate layer is provided, and
wherein the intermediate layer insulating material does not have lithium ion conductivity.

2. The lithium metal secondary battery according to claim 1, wherein in top view, an outer edge of the intermediate layer insulating material overlaps an outer edge of the solid electrolyte layer and is located outward of an outer edge of the lithium metal layer.

3. The lithium metal secondary battery according to claim 1, wherein in top view, an outer edge of the intermediate layer insulating material, an outer edge of the solid electrolyte layer, and an outer edge of the lithium metal layer overlap each other.

4. The lithium metal secondary battery according to claim 1, wherein in top view, an outer edge of the intermediate layer is located inward of an outer edge of the solid electrolyte layer and inward of an outer edge of the lithium metal layer.

5. The lithium metal secondary battery according to claim 1,
wherein the positive electrode layer comprises a positive electrode active material layer, and
wherein in top view, an outer edge of the positive electrode active material layer is located inward of an outer edge of the intermediate layer,
the outer edge of the intermediate layer overlaps an outer edge of the lithium metal layer or is located inward of the outer edge of the lithium metal layer, and
the outer edge of the lithium metal layer is located between edges of the intermediate layer insulating material.

6. The lithium metal secondary battery according to claim 1, wherein the intermediate layer insulating material includes alumina.
